(19) United States
(12) Patent Application Publication
(10) Pub. No.: US 2021/0213764 A1
(43) Pub. Date: Jul. 15, 2021

(54) THERMAL PRINTER

(71) Applicant: Mitsubishi Electric Corporation, Tokyo (JP)

(72) Inventor: Naoyuki ABE, Tokyo (JP)

(73) Assignee: Mitsubishi Electric Corporation, Tokyo (JP)

(21) Appl. No.: 17/047,187

(22) PCT Filed: Jun. 22, 2018
(86) PCT No.: PCT/JP2018/023787

§ 371 Date: Oct. 13, 2020

(51) Int. Cl. B41J 29/17; B41J 2/325

(52) U.S. Cl. CPC B41J 29/17; B41J 2/325

(57) ABSTRACT

A thermal printer uses an ink ribbon having a function of cleaning a thermal head by heating the ink ribbon. The thermal printer performs cleaning processing for cleaning the thermal head using a used region of the ink ribbon. In the cleaning processing, the thermal head applies to the used region of the ink ribbon the heat of the heat quantity which does not sublime the dye coated on the ink ribbon and which is for performing the cleaning.

### TECHNICAL FIELD

The present invention relates to a thermal printer having a function of cleaning a thermal head.

### BACKGROUND ART

In a thermal printer, it is required to regularly clean the thermal head. Japanese Patent Application Laid-Open No. 2016-193570 discloses a configuration for cleaning a thermal head (hereinafter, also referred to as “related configuration A”). In the related configuration A, a cassette head cleaner having a cleaning sheet is attached to a thermal printer to clean the thermal head. Thus, the deposit or the like deposited on the thermal head is removed.

### SUMMARY

### Problem to be Solved by the Invention

However, in the related configuration A, when the thermal head is cleaned, it is necessary to remove an ink ribbon (ink ribbon cassette) from the thermal printer, and then to attach the cassette head cleaner to the thermal printer. Therefore, when the thermal head is cleaned, there is a problem that it is necessary to use a cassette head cleaner dedicated to cleaning.

The present invention is made to solve this problem, and an object thereof is to provide a thermal printer capable of cleaning a thermal head without using a cassette head cleaner.

### Means to Solve the Problem

In order to achieve the above object, a thermal printer according to one aspect of the present invention performs printing processing for forming an image on the recording paper using the ink ribbon having a function of cleaning the thermal head by heating the ink ribbon. The thermal printer includes: the thermal head having a function of emitting heat; a print control unit configured to control the thermal head; and a conveyance unit having a function of conveying the ink ribbon. The ink ribbon has a used region. The used region is a region used in the printing processing in the ink ribbon. The conveyance unit conveys the ink ribbon before the cleaning processing is performed so that the thermal printer performs cleaning processing using the used region. The thermal printer performs the cleaning processing for performing the cleaning on the thermal head using the used region. In the cleaning processing, under control of the print control unit, the thermal head applies to the used region of the ink ribbon heat of heat quantity which does not sublime dye coated on the ink ribbon and which is for performing the cleaning.

### Effects of the Invention

According to the present invention, the thermal printer uses the ink ribbon having a function of cleaning the thermal head by heating the ink ribbon. The thermal printer performs cleaning processing for performing the cleaning on the thermal head using the used region. In the cleaning processing, the thermal head applies to the used region of the ink ribbon the heat of the heat quantity which does not sublime the dye coated on the ink ribbon and which is for performing the cleaning. Thus, the thermal head can be cleaned without using the cassette head cleaner.

In addition, the thermal printer performs the cleaning processing using the used region of the ink ribbon. Therefore, the cleaning processing can be performed without using an unused region of the ink ribbon.

The objects, characteristics, aspects, and advantages of the present invention will become more apparent from the following detailed description and the accompanying drawings.

### BRIEF DESCRIPTION OF DRAWINGS

FIG. 1 is a block diagram showing a schematic configuration of a thermal printer according to the first embodiment.

FIG. 2 is a diagram mainly showing a mechanical configuration for performing printing in the thermal printer according to the first embodiment.

FIG. 3 is a diagram for illustrating a part of the ink ribbon.

FIGS. 4A and 4B are diagrams mainly showing a mechanism that conveys the ink ribbon in the thermal printer according to the first embodiment.

FIGS. 5A and 5B are diagrams for illustrating the configuration of the ink conveyance unit.

FIG. 6 is a cross-sectional view of a back surface portion included in the ink ribbon.

FIG. 7 is a diagram showing the relationship between the friction coefficient and the print density.

FIG. 8 is a flowchart of a print preparation processing according to the first embodiment.

FIG. 9 is a flowchart of a print preparation processing A according to a second embodiment.

FIGS. 10A, 10B, and 10C are diagrams for illustrating a part of the print preparation processing A according to the second embodiment.

FIG. 11 is a block diagram illustrating a characteristic functional configuration of a thermal printer.

FIG. 12 is a hardware configuration diagram of the thermal printer.

### DESCRIPTION OF EMBODIMENTS

Hereinafter, embodiments will be described with reference to the drawings. In the following drawings, the same components are denoted by the same reference numerals. The names and functions of respective components denoted by the same reference numerals are the same. Therefore, a detailed description of a part of each component denoted by the same reference numeral may be omitted.

It should be noted that the dimensions, material, and shape of each component, relative arrangement of each component, and the like exemplified in the embodiments may be appropriately changed according to the configuration, various conditions, and the like of the apparatus to which the present invention is applied.

### First Embodiment

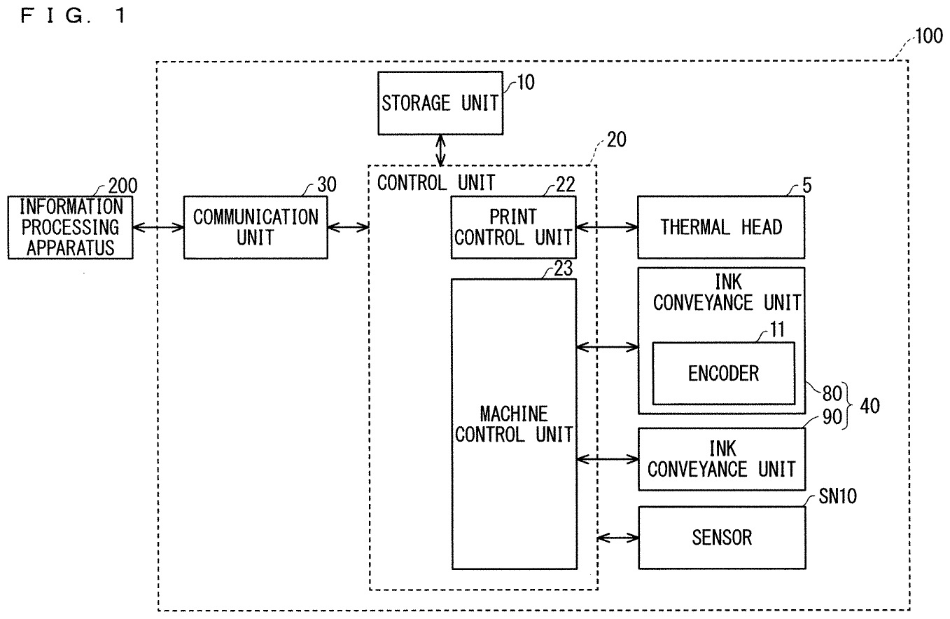

FIG. 1 is a block diagram showing a schematic configuration of a thermal printer 100 according to the first embodiment. It should be noted that FIG. 1 also shows an information processing apparatus 200 not included in the thermal printer 100 for the sake of illustration.

The thermal printer 100, which will be described in detail below, performs printing processing P for forming an image on recording paper 6 described below using an ink ribbon 7 described below. The information processing apparatus 200 is an apparatus that controls the thermal printer 100. The information processing apparatus 200 is a personal computer (PC), for example. The information processing apparatus 200 is operated by a user.

When the user performs a print execution operation on the information processing apparatus 200, the information processing apparatus 200 transmits print instructions and image data D1 to the thermal printer 100. The print execution operation is an operation for causing the thermal printer 100 to execute the printing processing P. In addition, the print instructions are instructions for causing the thermal printer 100 to execute the printing processing P. The image data D1 is data on an image for being printed on recording paper 6 described below.

With reference to FIG. 1, the thermal printer 100 includes a storage unit 10, a control unit 20, a communication unit 30, and a thermal head 5.

The storage unit 10 is a memory that stores various kinds of data, programs, and the like. The storage unit 10 includes, for example, a non-volatile memory and a volatile storage memory. The storage unit 10 stores, for example, a control program for controlling the thermal printer 100, data related to print control, image data, print data, various kinds of data, various set values, various initial values, and the like.

The thermal head 5 has a function of emitting heat. The thermal head 5, which will be described in detail below, emits heat under the control of the control unit 20.

The control unit 20 performs various kinds of processing on each unit of the thermal printer 100 according to the control program. The control unit 20 is a processor such as a central processing unit (CPU), for example.

The control unit 20, which will be described in detail below, mainly performs processing of controlling the entire thermal printer 100. In addition, the control unit 20 accesses the storage unit 10 to read the data and the like stored in the storage unit 10 as necessary.

The control unit 20 includes a print control unit 22 and a machine control unit 23. All or part of the print control unit 22 and the machine control unit 23 include a signal processing circuit including a hardware electric circuit. It should be noted that all or part of the print control unit 22 and the machine control unit 23 may be program modules executed by the control unit 20.

The print control unit 22 controls the thermal head 5. The print control unit 22, which will be described in detail below, performs processing for printing using the thermal head 5. The machine control unit 23, which will be described in detail below, controls a mechanical configuration (hereinafter, also referred to as “mechanical configuration”) included in the thermal printer 100.

The communication unit 30 communicates with the information processing apparatus 200 and the control unit 20. The print instructions and the image data D1 transmitted by the information processing apparatus 200 are transmitted to the control unit 20 via the communication unit 30. The communication unit 30 performs communication using, for example, a Universal Serial Bus (USB) interface.

The control unit 20 generates print data using the received image data D1 in accordance with the received print instructions. The print data is control data for printing the image represented by the image data D1 on the recording paper 6. The control unit 20 transmits the print data to the print control unit 22. The print control unit 22 controls the amount of heat generated by the thermal head 5 according to the print data. Thus, the image represented by the image data D1 is printed on the recording paper 6.

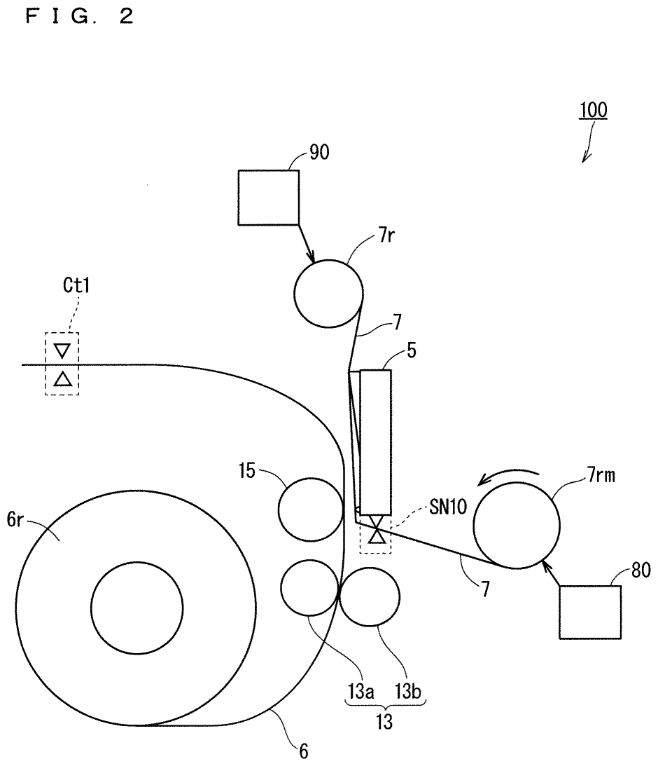

FIG. 2 is a diagram mainly showing a mechanical configuration for performing printing in the thermal printer 100 according to the first embodiment. It should be noted that FIG. 2 shows a state in which a roll paper 6r and the ink ribbon 7 are attached to the thermal printer 100. The roll paper 6r is configured by winding long recording paper 6 into a roll shape.

The thermal printer 100 is configured such that the recording paper 6 (roll paper 6r) can be attached to and detached from the thermal printer 100.

The ink ribbon 7 is a long sheet. Winding one end portion of the ink ribbon 7 in a roll shape forms an ink ribbon roll 7r. The ink ribbon roll 7r is a roll that supplies the ink ribbon 7 (hereinafter, also referred to as “supply side roll”).

Winding the other end portion of the ink ribbon 7 in a roll shape forms an ink ribbon roll 7rm. The ink ribbon roll 7rm is a roll for taking up the ink ribbon 7 (hereinafter, also referred to as “take-up side roll”).

The thermal printer 100 is configured such that the ink ribbon 7 (ink ribbon rolls 7r, 7rm) can be attached to and detached from the thermal printer 100.

The thermal printer 100, which will be described in detail below, performs printing processing P for forming an image on the recording paper 6. The printing processing P, which will be described in detail below, is processing for transferring dyes 7y, 7m, and 7c onto the recording paper 6.

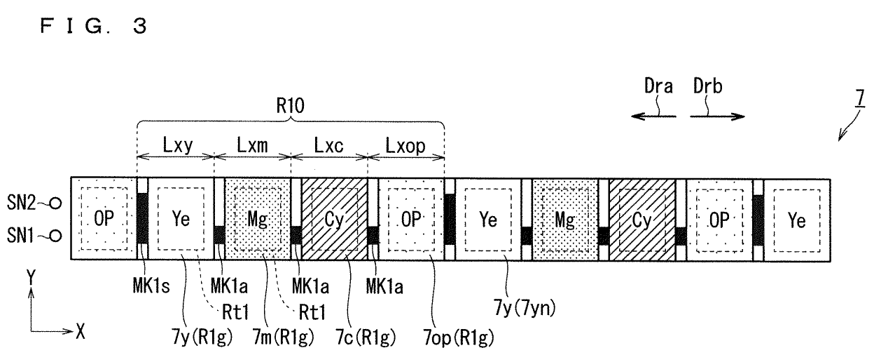

FIG. 3 is a diagram for illustrating a part of the ink ribbon 7. It should be noted that FIG. 3 also shows sensors SN1 and SN2 described below. In FIG. 3, the X direction and the Y direction are orthogonal to each other. The X direction and the Y direction illustrated in the following drawings are also orthogonal to each other.

Hereinafter, a direction including the X direction and a direction opposite to the X direction (−X direction) is also referred to as an “X-axis direction”. In addition, hereinafter, a direction including the Y direction and a direction opposite to the Y direction (−Y direction) is also referred to as “Y-axis direction”. In addition, hereinafter, a plane including the X-axis direction and the Y-axis direction is also referred to as “XY plane”.

With reference to FIG. 3, in the ink ribbon 7, a plurality of unit regions R10 each being provided with the dyes 7y, 7m, and 7c and a protective material 7op are formed along the longitudinal direction of the ink ribbon 7 (X-axis direction). That is, the ink ribbon 7 is coated with the dyes 7y, 7m, and 7c and the protective material 7op. Each of the dyes 7y, 7m, and 7c and the protective material 7op is a material to be transferred to the recording paper 6.

Each of the dyes 7y, 7m, and 7c and the protective material 7op is a transfer material to be transferred to the recording paper 6 by being heated by the thermal head 5. For example, the dye 7y is the first transfer material. That is, the dye 7y is a material to be first transferred to the recording paper 6 in the printing processing P. In addition, for example, the protective material 7op is the fourth transfer material.

Each of the dyes 7y, 7m, and 7c indicates a color to be transferred to the recording paper 6 being a transfer target. Specifically, the dyes 7y, 7m, and 7c show colors of yellow, magenta, and cyan, respectively. Hereinafter, yellow, magenta, and cyan are also referred to as “Ye”, “Mg”, and “Cy”, respectively. In addition, hereinafter, each of the Ye dye, the Mg dye, and the Cy dye is also referred to as “color dye”. Each of the dyes 7y, 7m, and 7c being color dyes is a dye used for forming an image.

The protective material 7op is a material (overcoat) for protecting the color transferred to the recording paper 6. Specifically, the protective material 7op is a material for protecting the image formed on the recording paper 6 by the dyes 7y, 7m, and 7c. Hereinafter, the protective material 7op is also referred to as “OP material”.

Each of the dyes 7y, 7m, and 7c and the protective material 7op being transfer materials has a transfer region Rt1. That is, the transfer region Rt1 exists in the ink ribbon 7. The transfer region Rt1 is a region to be the target of transfer in each transfer material. The transfer regions Rt1 of color dyes are coated with dyes (dyes 7y, 7m, and 7c) used for forming an image.

Hereinafter, in the recording paper 6, the region for forming an image is also referred to as “image forming region”. The shape and size of the image forming region are equal to the shape and size of the transfer region Rt1 in FIG. 3. In addition, hereinafter, the direction in which the ink ribbon 7 is conveyed so as to form an image in the image forming region of the recording paper 6 is also referred to as “forward conveying direction”. In FIG. 3, the forward conveying direction is the -X direction.

It should be noted that in the printing processing P, the dye 7y is first transferred to the image forming region of the recording paper 6. Thereafter, the dyes 7m, 7c, and the protective material 7op are transferred to the image forming region in the order of the dyes 7m, 7c, and the protective material 7op. Thus, an image to be expressed with the dyes 7y, 7m, and 7c is formed in the image forming region.

Hereinafter, the dye 7y is also referred to as “transfer material ma1”. In addition, hereinafter, the dye 7m is also referred to as “transfer material mb2”. In addition, hereinafter, the dye 7c is also referred to as “transfer material mb3”. In addition, hereinafter, the protective material lop is also referred to as “transfer material mb4”.

In the printing processing P, the transfer materials ma1, mb2, mb3, and mb4 are transferred to the image forming region of the recording paper 6 in the order of the transfer materials ma1, mb2, mb3, and mb4. Hereinafter, each of the transfer materials mb2, mb3, and mb4 is also simply referred to as “transfer material mb”. The transfer material mb is the second or later transfer material in the printing processing P.

In addition, the ink ribbon 7 is provided with a plurality of marks MK1a and a plurality of marks MK1s. The mark MK1a is a mark for specifying the position of the transfer material mb. Each of the marks MK1a and MK1s includes, for example, a black material.

The mark MK1a is provided in association with the transfer material mb. Specifically, the mark MK1a is provided in a region in the ink ribbon 7 on the forward conveying direction (−X direction) side of the transfer material mb so that the mark MK1a is adjacent to the transfer material mb. Here, it is assumed that the transfer material mb is the dye 7m (transfer material mb2). In this case, as shown in FIG. 3, the mark MK1a is provided in a region in the ink ribbon 7 on the forward conveying direction (−X direction) side of the dye 7m so that the mark MK1a is adjacent to the dye 7m.

The mark MK1s is a mark for specifying the position of the dye 7y (transfer material ma1) being the first transfer material. The mark MK1s is provided in association with the dye 7y. Specifically, the mark MK1s is provided in a region in the ink ribbon 7 on the forward conveying direction (−X direction) side of the dye 7y so that the mark MK1s is adjacent to the dye 7y.

With reference to FIGS. 1 and 2 again, the thermal printer 100 further includes a conveyance roller pair 13, a platen roller 15, a conveyance unit 40, a sensor SN10, and a cutting unit Ct1.

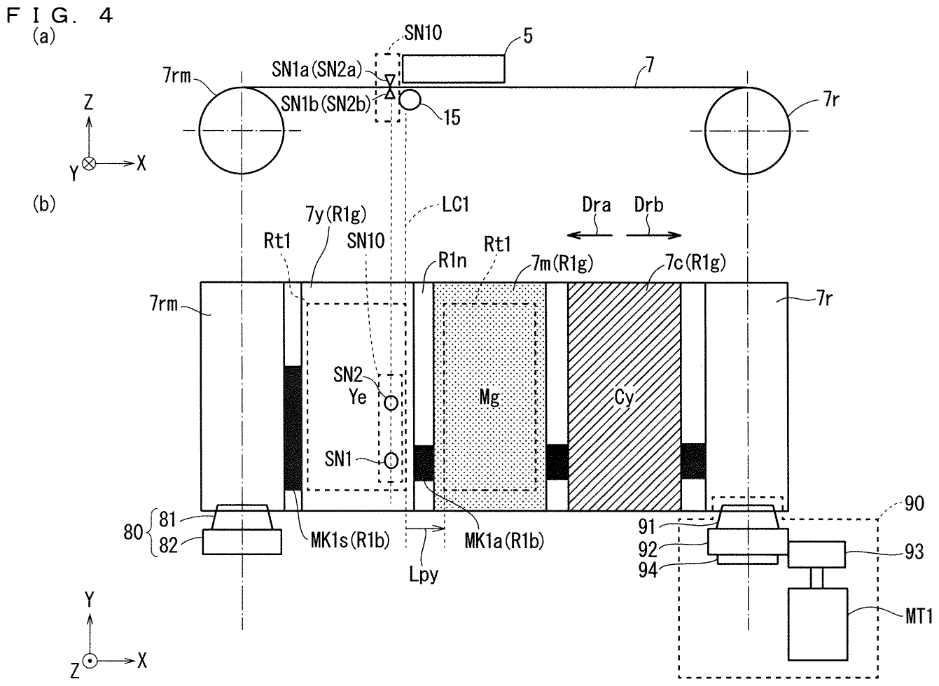

FIGS. 4A and 4B are diagrams mainly showing a mechanism that conveys the ink ribbon 7 in the thermal printer 100 (hereinafter, also referred to as “conveying mechanism”) according to the first embodiment. FIG. 4A is a side view of the conveying mechanism. It should be noted that in FIG. 4A, a part of each component (for example, the ink ribbon roll 7rm) is shown at a position different from the actual position in order to make the conveying mechanism easy to understand.

In FIG. 4A, the X direction, the Y direction, and the Z direction are orthogonal to one another. The X, Y, and Z directions illustrated in the following drawings are also orthogonal to one another. As described above, a direction including the X direction and a direction opposite to the X direction (−X direction) is also referred to as “X-axis direction”. In addition, as described above, a direction including the Y direction and a direction opposite to the Y direction (−Y direction) is also referred to as “Y-axis direction”. Hereinafter, a direction including the Z direction and a direction opposite to the Z direction (−Z direction) is also referred to as “Z-axis direction”.

In addition, as described above, a plane including the X-axis direction and the Y-axis direction is also referred to as “XY plane”. Hereinafter, a plane including the X-axis direction and the Z-axis direction is also referred to as “XZ plane”. In addition, hereinafter, a plane including the Y-axis direction and the Z-axis direction is also referred to as “YZ plane”. FIG. 4B is a plan view of the conveying mechanism.

With reference to FIGS. 1, 2, 4A, and 4B, the conveyance roller pair 13 is a roller pair for conveying the recording paper 6. The conveyance roller pair 13 includes a grip roller 13a and a pinch roller 13b. The grip roller 13a rotates along with the drive of a rotation drive unit (not shown) such as a motor.

The platen roller 15 is in contact with the recording paper 6 conveyed by the conveyance roller pair 13. The platen roller 15 is provided so as to face a part of the thermal head 5.

The conveyance unit 40 is a mechanism having a function of conveying the ink ribbon 7. The conveyance unit 40 includes ink conveyance units 80 and 90. The ink conveyance unit 80, which will be described in detail below, conveys the ink ribbon 7 in the forward conveying direction (−X direction) under the control of the machine control unit 23.

Hereinafter, the amount by which the ink ribbon 7 is conveyed is also referred to as “conveyance amount”. The conveyance amount is also a distance that the ink ribbon 7 moves. The ink conveyance unit 80 has a function of controlling the conveyance amount of the ink ribbon 7 using an encoder 11 described below.

Hereinafter, the direction opposite to the forward conveying direction is also referred to as “reverse conveying direction”. In FIG. 4A, the reverse conveying direction is the X direction. The ink conveyance unit 90, which will be described in detail below, conveys the ink ribbon 7 in the reverse conveying direction (X direction) under the control of the machine control unit 23.

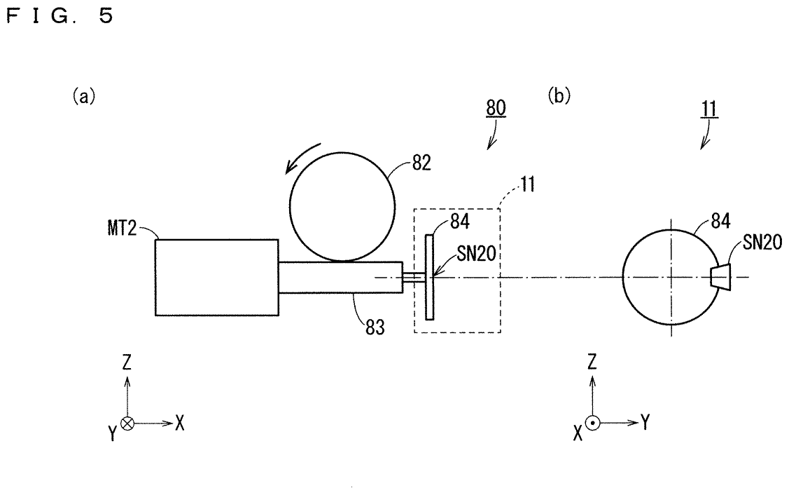

FIGS. 5A and 5B are diagrams for illustrating the configuration of the ink conveyance unit 80. FIG. 5A is a diagram showing a configuration of the ink conveyance unit 80 along the XZ plane. FIG. 5B is a diagram showing a configuration of an encoder 11 described below included in the ink conveyance unit 80, along the YZ plane.

With reference to FIGS. 4B, 5A, and 5B, the ink conveyance unit 80 includes an attachment 81, a take-up side gear 82, a motor gear 83, a motor MT2, and an encoder 11.

The attachment 81 is fixed to the side surface of the ink ribbon roll 7rm. The motor gear 83 is a rod-shaped member. The outer surface of the motor gear 83 is provided with a gear. The motor gear 83 is attached to the motor MT2. The motor MT2 rotates the motor gear 83 under the control of the machine control unit 23.

The take-up side gear 82 is fixed to the attachment 81. In addition, the take-up side gear 82 is provided so as to mesh with a gear on the outer surface of the motor gear 83. Thus, the motor MT2 rotates the motor gear 83 to allow the ink ribbon roll 7rm to rotate via the take-up side gear 82 and the attachment 81.

The motor MT2 performs control for conveying the ink ribbon 7 in the forward conveying direction (−X direction) as necessary. Specifically, the motor MT2 rotates the ink ribbon roll 7rm in the counterclockwise direction by rotating the motor gear 83 so that the take-up side gear 82 rotates in the counterclockwise direction. Thus, the ink ribbon 7 is conveyed in the forward conveying direction (−X direction).

It should be noted that the ink ribbon roll 7r also rotates so that the tension applied to the ink ribbon 7 is kept constant as the ink ribbon roll 7rm rotates. Therefore, as the ink ribbon roll 7rm takes up a part of the ink ribbon 7, the ink ribbon roll 7r supplies the ink ribbon 7 by the length of the taken-up ink ribbon 7.

The encoder 11 includes a rotating member 84 and a sensor SN20. The rotating member 84 is a disk-shaped member. The rotating member 84 is fixed to an end portion of the motor gear 83. Thus, the rotating member 84 rotates as the motor gear 83 rotates. The rotating member 84 is provided with a plurality of slits (not shown) in a circular shape.

The sensor SN20 has a function of detecting each slit of the rotating member 84 being rotating. Every time detecting the slit of the rotating member 84, the sensor SN20 transmits a pulse (signal) to the control unit 20.

Next, the ink conveyance unit 90 will be described. With reference to FIG. 4B, the ink conveyance unit 90 includes an attachment 91, a supply side gear 92, a motor gear 93, a torque limiter 94, and a motor MT1.

The attachment 91 is fixed to a side surface of the ink ribbon roll 7r. The supply side gear 92 is fixed to the attachment 91. It should be noted that the supply side gear 92 is provided with the torque limiter 94 for adjusting the rotational force (torque) of the ink ribbon roll 7r. The side surface of the supply side gear 92 is provided with a gear.

The motor gear 93 is attached to the motor MT1. The motor gear 93 is provided so as to mesh with a gear on the side surface of the supply side gear 92. The motor MT1 rotates the motor gear 93 under the control of the machine control unit 23. The motor MT1 rotates the motor gear 93 to allow the ink ribbon roll 7r to rotate via the supply side gear 92 and the attachment 91.

The motor MT1 performs control for conveying the ink ribbon 7 in the reverse conveying direction (X direction) as necessary. Specifically, the motor MT1 rotates the motor gear 93 so that the supply side gear 92 (ink ribbon roll 7r) rotates in the clockwise direction. Thus, the ink ribbon 7 is conveyed in the reverse conveying direction (X direction). That is, the ink ribbon 7 can be rewound to the ink ribbon roll 7rm by the operation of the motor MT1. It should be noted that the ink ribbon roll 7rm also rotates as the ink ribbon roll 7r rotates. Hereinafter, the path along which the ink ribbon 7 is conveyed is also referred to as “conveyance path”.

Next, the sensor SN10 will be described. The sensor SN10 has a function of detecting the marks MK1a and MK1s when the ink ribbon 7 is being conveyed by the conveyance unit 40. The sensor SN10 is provided at a position on the upstream side of the thermal head 5 in the conveyance path along which the ink ribbon 7 is conveyed.

The sensor SN10 has a function of measuring the light transmittance of the ink ribbon 7 using light. In other words, the sensor SN10 has a function of detecting the marks MK1a and MK1s using the light transmittance of the ink ribbon 7.

The sensor SN10 includes a sensor SN1 and a sensor SN2. The sensor SN1 has the same configuration and function as the sensor SN2.

The sensor SN1 has a function of detecting the marks MK1a and MK1s. That is, the mark MK1s is provided in the region in the ink ribbon 7 to be detected by both the sensor SN1 and the sensor SN2. That is, the length of the mark MK1s in the Y-axis direction is larger than the length of the mark MK1a in the Y-axis direction so that the mark MK1s is detected by both the sensor SN1 and the sensor SN2.

The sensor SN2 has a function of detecting the mark MK1s.

In addition, each of the sensor SN1 and the sensor SN2 has a function of measuring the light transmittance of the ink ribbon 7 using light. The sensor SN1 includes a light emitting unit SN1a and a light receiving unit SN1b. The light emitting unit SN1a and the light receiving unit SN1b are provided so as to sandwich the ink ribbon 7.

In addition, the sensor SN2 includes a light emitting unit SN2a and a light receiving unit SN2b. The light emitting unit SN2a and the light receiving unit SN2b are provided so as to sandwich the ink ribbon 7. The light emitting unit SN2a and the light receiving unit SN2b have the same functions as the light emitting unit SN1a and the light receiving unit SN1b, respectively.

Hereinafter, the region where each of sensor SN1 and SN2 is provided is also called “sensor region”. The sensor region is, for example, a region where each of the sensors SN1 and SN2 is provided in FIG. 4B. In addition, hereinafter, the light emitted by the light emitting unit SN1a of the sensor SN1 or the light emitted by the light emitting unit SN2a of the sensor SN2 is also referred to as “sensor light”.

In addition, hereinafter, in the ink ribbon 7, the region coated with any one of the color dye and the protective material lop is also referred to as “transfer material region R1g”. The color dye is any one of the dyes 7y, 7m, and 7c.

In addition, hereinafter, in the ink ribbon 7, the region provided with any one of the marks MK1a and MK1s is also referred to as “mark region R1b”. In addition, hereinafter, in the ink ribbon 7, the region other than the transfer material region R1g and the mark region R1b is also referred to as “plain region R1n”. The plain region R1n is, for example, a transparent region. In addition, hereinafter, the ratio of the amount of light received by the light receiving unit SN1b to the amount of light emitted by the light emitting unit SN1a is also referred to as “light transmittance” or “light transmittance Tr”.

Next, the processing performed by the sensor SN1 (hereinafter, also referred to as “sensor processing”) will be described. In the sensor processing, the light emitting unit SN1a emits light to the ink ribbon 7. The light receiving unit SN1b receives, in the light emitted by the light emitting unit SN1a, light transmitted through any one of the transfer material region R1g, the mark region R1b, and the plain region R1n included in the ink ribbon 7.

In addition, in the sensor processing, the light receiving unit SN1b calculates the light transmittance being the ratio of the amount of light received by the light receiving unit SN1b to the amount of light emitted by the light emitting unit SN1a. With the above method, the sensor SN1 always measures the light transmittance.

In addition, in the sensor processing, the sensor SN1 always continues to transmit the detected signal to the control unit 20. In the sensor processing, when the latest light transmittance is less than the threshold value Th1, the sensor SN1 sets the level of the detected signal to the L level. The threshold value Th1 is a value for detecting the marks MK1a and MK1s. The threshold value Th1 is, for example, a value in the range of 0.01 to 0.2 times the light transmittance of the plain region R1n.

For example, if there exists a mark region R1b in which any one of the marks MK1a and MK1s is provided between the light receiving unit SN1b and the light emitting unit SN1a, the light receiving unit SN1b determines that the latest light transmittance is less than the threshold value Th1. The latest light transmittance's being less than the threshold value Th1 causes the sensor SN1 to detect any one of the marks MK1a and MK1s.

The sensor SN1 sets the level of the detected signal to the L level during the period in which the sensor SN1 detects any one of the marks MK1a and MK1s. In addition, the sensor SN1 sets the level of the detected signal to the H level when the latest light transmittance is not less than the threshold value Th1.

It should be noted that as described above, the sensor SN1 has the same configuration and function as the sensor SN2. Therefore, the operation and configuration of the sensor SN2 (light emitting unit SN2a and light receiving unit SN2b) are the same as those of the sensor SN1 (light emitting unit SN1a and light receiving unit SN1b), so that detailed description thereof will not be repeated.

That is, the sensor SN2 performs sensor processing similarly to the sensor SN1. That is, the light emitting unit SN2a and the light receiving unit SN2b perform the sensor processing similarly to the light emitting unit SN1a and the light receiving unit SN1b.

Hereinafter, the position where the thermal head 5 emits heat (heater line) is also referred to as “heating position LC1”. The heating position LC1 is, for example, the position shown in FIGS. 4A and 4B. It should be noted that as described above, the sensor SN10 is provided at a position on the upstream side of the thermal head 5 in the conveyance path along which the ink ribbon 7 is conveyed. That is, the sensor SN10 (sensors SN1 and SN2) is provided at a position on the upstream side of the heating position LC1 (heater line) in the conveyance path along which the ink ribbon 7 is conveyed.

Hereinafter, the direction in which the recording paper 6 is conveyed is also referred to as “paper conveying direction”. In addition, hereinafter, the length of the above-described image forming region in the paper conveying direction in the recording paper 6 is also referred to as “transfer length Lsp”. In addition, hereinafter, the direction in which the ink ribbon 7 is conveyed is also referred to as “ribbon conveying direction”. The ribbon conveying direction is the X-axis direction including the forward conveying direction (−X direction) and the reverse conveying direction (X direction) described above. In addition, hereinafter, the length of the transfer region Rt1 in the ribbon conveying direction (X-axis direction) in the ink ribbon 7 is also referred to as “transfer length Lsa”. The transfer length Lsa is the same as the transfer length Lsp.

Hereinafter, the direction in which recording paper 6 is conveyed in order to form an image in the image forming region of the recording paper 6 is also referred to as “paper forward conveying direction”. In FIG. 4B, the paper forward conveying direction is the −X direction. Hereinafter, the direction opposite to the paper forward conveying direction is also referred to as “paper reverse conveying direction”. The paper reverse conveying direction is a direction in which the recording paper 6 is directed toward the paper ejection side. In FIG. 4B, the paper reverse conveying direction is the X direction.

Next, the printing processing P will be briefly described. The printing processing P is processing of sequentially transferring the first to fourth transfer materials to the image forming region of the recording paper 6. The first to fourth transfer materials are the dyes 7y, 7m, and 7c, and the protective material 7op, respectively. In order to simplify the description, immediately before the printing processing P is performed, the position of the tip of the image forming region of the recording paper 6, and the position of the tip of the transfer region Rt1 in the first transfer material in the ink ribbon 7 are assumed to be the heating position LC1.

Hereinafter, the state of the platen roller 15 when the platen roller 15 is in contact with the thermal head 5 with the recording paper 6 and the ink ribbon 7 interposed therebetween is also referred to as “platen contact state”. In addition, hereinafter, the state of the platen roller 15 when the platen roller 15 is separated from the recording paper 6 is also referred to as “platen non-contact state”. The printing processing P is performed when the platen roller 15 is in the platen contact state.

In the printing processing P, unit printing processing is performed. In the unit printing processing, ribbon conveying processing, paper conveying processing, and transfer processing are simultaneously performed. In addition, the following ribbon conveying processing, paper conveying processing, and transfer processing are performed in a state where the heater line (heating position LC1) is at the position of the tip of the transfer region Rt1 in the transfer material by the ink ribbon 7 being conveyed under the control of the control unit 20 (machine control unit 23). The tip of the transfer region Rt1 is, for example, the left end in the X-axis direction of the transfer region Rt1 in the dye 7y in FIG. 4B.

In the ribbon conveying processing, the ink ribbon 7 is drawn out from the ink ribbon roll 7r by the transfer length Lsa. Thus, the ink ribbon 7 is conveyed for a predetermined time. It should be noted that in the ribbon conveying processing, the conveyance unit 40 conveys the ink ribbon 7 in the forward conveying direction (−X direction) with the ink ribbon 7 being in contact with the thermal head 5.

In addition, in the paper conveying processing, the recording paper 6 is conveyed by the conveyance roller pair 13. Specifically, the recording paper 6 is drawn out from the roll paper 6r by the conveyance roller pair 13 by the transfer length Lsp. Thus, the recording paper 6 is conveyed for a predetermined time in a state of being sandwiched by the conveyance roller pair 13.

In the transfer processing, the thermal head 5 heats the u-th transfer material existing at the heating position LC1 during the period in which the ink ribbon 7 and the recording paper 6 are being conveyed. The “u” is a natural number of one or more. When the transfer processing is performed for the first time, u is 1. It should be noted that the amount of heating by the thermal head 5 is controlled by the print control unit 22 based on the print data described above. Thus, the transfer material of the ink ribbon 7 is transferred to the image forming region of the recording paper 6.

Then, the ink ribbon 7 is taken up by the ink ribbon roll 7rm so that the position of the tip of the transfer region Rt1 in the next transfer material is the heating position LC1. In addition, the recording paper 6 is taken up by the roll paper 6r so that the position of the tip of the image forming region of the recording paper 6 is the heating position LC1.

The above unit printing processing is performed on each of the second to fourth transfer materials in the same manner as above. Then, the printing processing P ends. Thus, the dyes 7y, 7m, and 7c, and the protective material 7op are transferred to the image forming region in the order of the dyes 7y, 7m, and 7c, and the protective material 7op. Thus, an image is formed in the image forming region. Hereinafter, an object obtained by forming an image in the image forming region of the recording paper 6 is also referred to as “printed object”. The printed object is a part of the recording paper 6.

Then, the recording paper 6 is conveyed by a predetermined length and cut into a predetermined dimension by the cutting unit Ct1. Thus, a printed object being a part of the recording paper 6 is generated. In addition, the printed object is ejected from the thermal printer 100 by a paper ejecting mechanism (not shown).

Next, a detailed configuration of the ink ribbon 7 will be described. Hereinafter, a portion on the back surface side of the ink ribbon 7 is also referred to as “back surface portion 70r”. The ink ribbon 7 includes a back surface portion 70r.

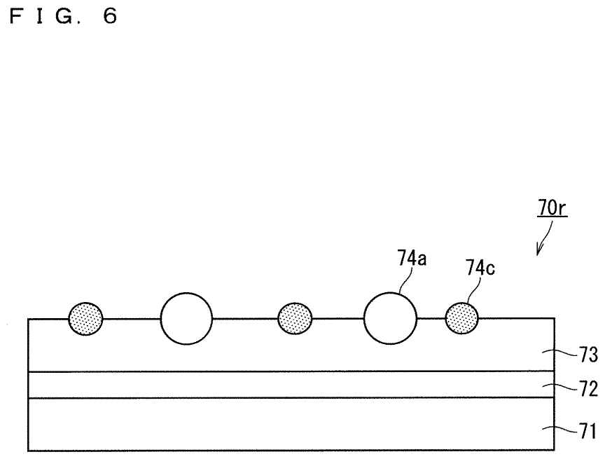

FIG. 6 is a cross-sectional view of the back surface portion 70r included in the ink ribbon 7. The upper surface of the back surface portion 70r is a surface that comes into contact with the thermal head 5 when the printing processing P is performed. It should be noted that a transfer material (not shown) (for example, dye 7y) is provided below the back surface portion 70r.

With reference to FIG. 6, the back surface portion 70r includes a base material layer 71, a primer layer 72, and a binder layer 73. The binder layer 73 is made of resin. The front surface (upper surface) of the binder layer 73 is coated with a plurality of slippery components 74a and a plurality of cleaning components 74c. The front surface of the binder layer 73 is the back surface of the ink ribbon 7.

In a normal temperature environment, the slippery component 74a is solid. The normal temperature environment is, for example, an environment where the temperature is less than 40 degrees. The application of heat to the slippery component 74a from the thermal head 5 dissolves the slippery component 74a. The slippery component 74a has a characteristic that the larger the amount of heat given to the slippery component 74a, the greater the dissolution amount of the slippery component 74a. The slippery component 74a is, for example, a material that functions as a lubricant. The cleaning component 74c is, for example, talc.

Hereinafter, the state in which the ink ribbon 7 being conveyed is in contact with the thermal head 5 is also referred to as “ribbon contact state”. In addition, hereinafter, the frictional force occurring between the thermal head 5 and the ink ribbon 7 in the ribbon contact state is also referred to as “head frictional force”. In addition, hereinafter, the coefficient based on the head frictional force is also referred to as “friction coefficient Fc” or “Fc”. The larger the value of the friction coefficient Fc, the larger the head frictional force.

It should be noted that when each of the slippery components 74a is heated by the thermal head 5 and each of the slippery components 74a is dissolved, the head frictional force is reduced. In addition, when each of the slippery components 74a is dissolved, each of the cleaning components 74c suppresses the residue occurring on the upper surface of the back surface portion 70r from adhering to the thermal head 5.

Hereinafter, the image to be formed on the recording paper 6 by the printing processing P is also referred to as “target image”. In addition, hereinafter, the value of each of a plurality of pixels constituting the target image is also referred to as “print density Dn” or “Dn”.

Hereinafter, the maximum heat quantity in a range of the heat quantity that does not sublime the transfer material is also referred to as “heat quantity Hq0”. The heat quantity Hq0 is heat quantity that does not sublime the color dye when the heat of the heat quantity Hq0 is applied to the color dye by the above-described transfer processing. The color dye is any one of dyes 7y, 7m, and 7c.

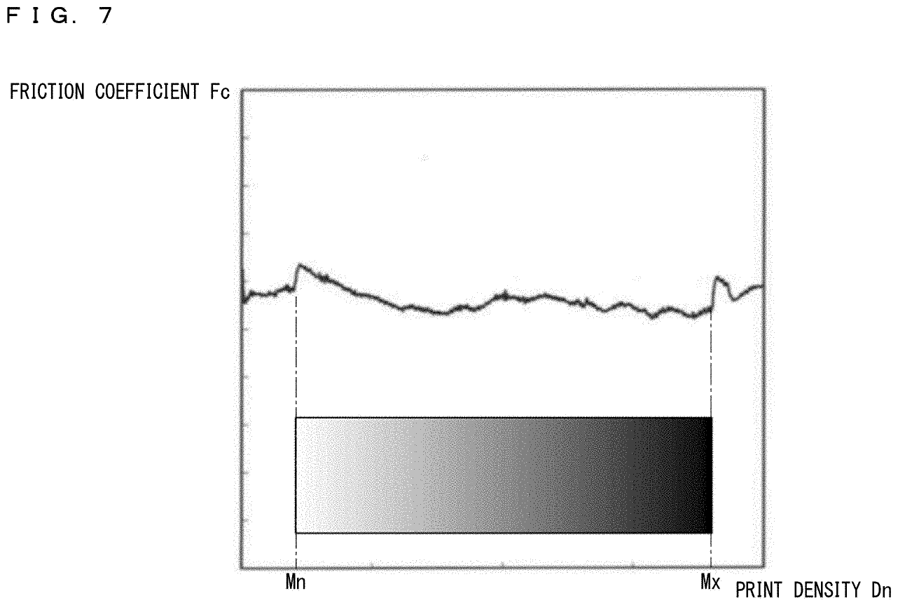

FIG. 7 is a diagram showing the relationship between the friction coefficient Fc and the print density Dn. In FIG. 7, the vertical axis represents the friction coefficient Fc. The horizontal axis represents the print density Dn. The print density Dn is expressed by an 8-bit numerical value, for example. That is, the print density Dn is expressed by 0 to 255. In this case, the minimum value Mn of the print density Dn is 0. The maximum value Mx of the print density Dn is 255. The print density Dn indicating the minimum value Mn is a density corresponding to the heat quantity Hq0.

As shown in FIG. 7, the magnitude of the head frictional force varies depending on the magnitude of the print density Dn. Specifically, the closer the print density Dn is to the minimum value Mn, the larger the value of the friction coefficient Fc. That is, the closer the print density Dn is to the minimum value Mn, the larger the head frictional force.

When the heat of the heat quantity Hq0 corresponding to the print density Dn indicating the minimum value Mn is applied to the ink ribbon 7, the dissolution amount of the slippery component 74a is very small. Therefore, the head frictional force in a state where the heat of the heat quantity Hq0 is applied to the ink ribbon 7 is large. In this case, conveying the ink ribbon 7 with the ink ribbon 7 being in contact with the thermal head 5 allows the deposit present on the thermal head 5 to be removed. Thus, the thermal head 5 can be cleaned. The deposit is, for example, a residue of the ink ribbon 7 generated by the printing processing P performed in the past. In addition, the deposit is, for example, dust or the like.

(Characteristic Processing)

Next, processing performed by the thermal printer 100 (hereinafter, also referred to as “print preparation processing”) will be described. The print preparation processing is performed when the user performs both or one of the paper mounting operation and the ink ribbon mounting operation. The paper mounting operation is an operation for mounting the recording paper 6 (roll paper 6r) on the thermal printer 100. The ink ribbon mounting operation is an operation for mounting the ink ribbon 7 (ink ribbon rolls 7r and 7rm) on the thermal printer 100.

Hereinafter, the tip portion of the recording paper 6 that constitutes the roll paper 6r is also referred to as “paper tip portion”. The paper tip portion is a portion that the user may touch when the user performs a paper mounting operation, for example.

The thermal printer 100 has a function of performing feed and cut (hereinafter, also referred to as “feed cutting processing”). The feed cutting processing is processing of cutting the recording paper 6 so that the paper tip portion is separated from the recording paper 6. The print preparation processing includes feed cutting processing. When the feed cutting processing is performed, the paper tip portion is ejected from the thermal printer 100.

Hereinafter, the processing of cleaning the thermal head 5 is also referred to as “cleaning processing”. The thermal printer 100 performs cleaning processing, which will be described in detail below. In addition, hereinafter, the number of times the thermal printer 100 performs the cleaning processing is also referred to as “cleaning frequency Kc” or “Kc”. The cleaning frequency Kc is stored in the storage unit 10 in advance. The value of the cleaning frequency Kc is one or more.

Hereinafter, the region to be used in the cleaning processing in the paper tip portion of the recording paper 6 is also referred to as “paper cleaning region”. That is, the paper tip portion includes the paper cleaning region. The length of the paper cleaning region in the paper conveying direction is shorter than the length of the paper tip portion in the paper conveying direction.

The paper mounting operation and the ink ribbon mounting operation are performed, for example, when neither the ink ribbon 7 nor the recording paper 6 (roll paper 6r) is mounted on the thermal printer 100.

In addition, for example, the paper mounting operation is performed to cancel the paper error when a paper error related to the recording paper 6 occurs. The paper error occurs, for example, when a paper shortage occurs (that is, when the length of the recording paper becomes not more than the length necessary to perform the printing processing P).

In addition, for example, the ink ribbon mounting operation is performed to cancel the ink error when the ink error related to the ink ribbon 7 occurs. The ink error occurs, for example, when an ink ribbon shortage occurs.

Hereinafter, the forward conveying direction (−X direction) is also referred to as “direction Dra”. In addition, hereinafter, the reverse conveying direction (X direction) is also referred to as “direction Drb”. In addition, hereinafter, the transfer material used in the printing processing P is also referred to as “used transfer material”. In addition, hereinafter, the region including all the used transfer materials in the ink ribbon 7 is also referred to as “used region Ru1”. That is, the used region Ru1 is a region used in the printing processing P in the ink ribbon 7.

Hereinafter, the dye 7y existing near the center of the ink ribbon 7 in FIG. 3 is also referred to as “dye 7yn” or “7yn”. Here, in FIG. 3, it is assumed that all the transfer materials existing on the direction Dra side of the dye 7yn are used transfer materials. In this case, the region where all the used transfer materials existing on the direction Dra side of the dye 7yn is the used region Ru1 of the ink ribbon 7.

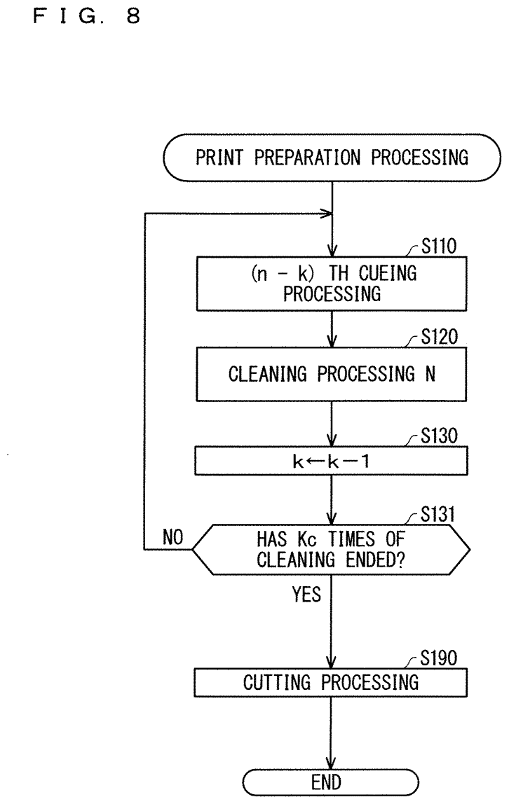

FIG. 8 is a flowchart of the print preparation processing according to the first embodiment. Here, in order to describe an example of the print preparation processing, the following premise Pm1 is considered.

On the premise Pm1, performing one time or more of the printing processing P uses a part of the ink ribbon 7. That is, on the premise Pm1, the used transfer material exists, and the ink ribbon 7 has the used region Ru1. In addition, on the premise Pm1, the paper mounting operation and the ink ribbon mounting operation are performed.

Hereinafter, the transfer material existing at the heating position LC1 when the ink ribbon mounting operation is performed is also referred to as “reference transfer material”. It should be noted that the reference transfer material is not the used transfer material. Hereinafter, the reference transfer material is also referred to as “n-th transfer material”. The “n” is a natural number. The value of “n” is greater than Kc.

Hereinafter, the (n−k)th transfer material is also referred to as “target transfer material”. The “k” is a natural number. The initial value of k is Kc. The target transfer material being the (n−k)th transfer material is the transfer material existing on the direction Dra side of the reference transfer material.

Here, in FIG. 3, it is assumed that the reference transfer material is dye 7yn (dye 7y) and k (Kc) is 1. In this case, the (n−k)th transfer material (target transfer material) is the protective material lop existing on the direction Dra side of the dye 7yn.

Here, in FIG. 3, it is assumed that the reference transfer material is dye 7yn (dye 7y) and k (Kc) is 2. In this case, the (n−k)th transfer material (target transfer material) is the dye 7c existing on the direction Dra side of the dye 7yn. The larger the value of k, the larger the distance between the reference transfer material and the target transfer material in the direction Dra.

In addition, on the premise Pm1, all the transfer materials existing on the direction Dra side of the dye 7yn in FIG. 3 are used transfer materials. In addition, on the premise Pm1, the ink ribbon mounting operation is performed by the user so that the heating position LC1 is a position within the transfer region Rt1 of the dye 7yn in FIG. 3. That is, on the premise Pm1, the reference transfer material (n-th transfer material) is the dye 7yn (dye 7y).

In addition, on the premise Pm1, the value of the cleaning frequency Kc is 2. As described above, the initial value of k is Kc. Therefore, on the premise Pm1, the target transfer material being the (n−k)th transfer material is the dye 7c being the used transfer material. In addition, the target transfer material exists within the used region Ru1 of the ink ribbon 7.

In addition, hereinafter, the position for performing the above-described transfer processing on the transfer material is also referred to as “printing start position”. In addition, hereinafter, the cleaning processing included in the print preparation processing is also referred to as “cleaning processing N”. In addition, on the premise Pm1, performing the paper mounting operation and the ink ribbon mounting operation executes the print preparation processing.

In the print preparation processing, the processing of steps S110, S120, S130, and S131 is performed in the order of the steps S110, S120, S130, and S131.

In step S110, the (n−k)th cueing processing is performed. In the (n−k)th cueing processing, the target transfer material being the (n−k)th transfer material is cued.

In the first (n−k)th cueing processing on the premise Pm1, the target transfer material (dye 7c) being the (n−2)th transfer material is cued.

Specifically, the conveyance unit 40 conveys (rewinds) the ink ribbon 7 in the direction Drb so that the position of the target transfer material is the printing start position. The conveyance of the ink ribbon 7 by the conveyance unit 40 is performed based on the detection state of the marks MK1s and MK1a by the sensor SN10 (sensors SN1 and SN2).

In addition, in the (n−k)th cueing processing, the cueing of the paper cleaning region at the paper tip portion is performed. Specifically, the conveyance roller pair 13 conveys the recording paper 6 so that the position of the paper cleaning region is the printing start position.

In step S120, the cleaning processing N is performed. The cleaning processing N is performed using the used region Ru1 of the ink ribbon 7. That is, the thermal printer 100 performs the cleaning processing N using the used region Ru1 of the ink ribbon 7.

Specifically, the cleaning processing N is performed using the entire transfer region Rt1 of the target transfer material (for example, the dye 7c) included in the used region Ru1. That is, the thermal printer 100 performs the cleaning processing N using the entire transfer region Rt1 included in the used region Ru1 of the ink ribbon 7.

In the cleaning processing N on the premise Pm1, the state of the platen roller 15 is set to the above-described platen contact state. Next, with the target transfer material as a target, the above-described ribbon conveying processing, the above-described paper conveying processing for conveying the paper tip portion (paper cleaning region), and the transfer processing N are simultaneously performed.

In the ribbon conveying processing, the conveyance unit 40 conveys the ink ribbon 7 in the direction Dra with the ink ribbon 7 being in contact with the thermal head 5.

In the transfer processing N, during the period in which the ink ribbon 7 and the recording paper 6 are being conveyed, the thermal head 5 applies the heat of the above-described heat quantity Hq0 to the used region Ru1 of the ink ribbon 7 under the control of the print control unit 22. As described above, the heat quantity Hq0 is the heat quantity that does not sublime the color dye (for example, the dye 7c). Specifically, in the transfer processing N, the thermal head 5 applies the heat of the heat quantity Hq0 to the entire transfer region Rt1 of the target transfer material included in the used region Ru1. As described above, the head frictional force in a state where the heat of the heat quantity Hq0 is applied to the ink ribbon 7 is large.

The ribbon conveying processing and the transfer processing N can remove the above-described deposit existing on the thermal head 5. The deposit is, for example, dust attached to the thermal head 5 when the ink ribbon mounting operation is performed. In addition, the deposit is, for example, a back surface residue of the ink ribbon 7 occurring due to the printing processing P performed in the past. The back surface residue is a residue occurring on the upper surface of the back surface portion 70r.

That is, the thermal head 5 can be cleaned with the ink ribbon 7. Therefore, the heat quantity Hq0 described above is the heat quantity for cleaning the thermal head 5. With the above, the ink ribbon 7 has a function of cleaning the thermal head 5 by heating the ink ribbon 7.

In step S130, the control unit 20 decrements the value of k by 1.

In step S131, it is determined whether Kc times of cleaning processing has ended. Specifically, the control unit 20 determines whether the cleaning processing N has been performed Kc times. If the value of k is 0, the control unit 20 determines that the cleaning processing N has been performed Kc times. On the other hand, if the value of k is 1 or more, the control unit 20 determines that the cleaning processing N has not been performed Kc times.

If YES in step S131, the processing proceeds to step S190. On the other hand, if NO in step S131, the processing in step S110 is performed again.

On the premise Pm1, Kc is 2, and the k at the time when the processing in step S131 is performed for the first time is 1, so that NO is determined in step S131 and the processing in step S110 is performed again.

It should be noted that in the second (n−k)th cueing processing on the premise Pm1, the processing for cueing the (n−1)th transfer material is performed in the same manner as described above. In addition, in the second (n−k)th cueing processing, the cueing of the paper cleaning region at the paper tip portion is performed as described above.

In the print preparation processing, the processing in steps S110 to S130 are repeated until YES is determined in step S131. On the premise Pm1, the (n−k)th cueing processing and the cleaning processing N are performed Kc times. In this case, in the cleaning processing N, regions of different target transfer materials are used in the ink ribbon 7 each time. In addition, in the cleaning processing N, the same paper cleaning region is used on the recording paper 6 each time. If YES is determined in step S131, the processing proceeds to step S190.

In step S190, cutting processing is performed. The cutting processing is feed cutting processing. In the cutting processing, the recording paper 6 including the paper tip portion is conveyed by a predetermined length. Then, the cutting unit Ct1 cuts the recording paper 6 so that the paper tip portion is cut off from the recording paper 6. Then, the paper ejecting mechanism (not shown) ejects the paper tip portion including the paper cleaning region from the thermal printer 100. With the above, the print preparation processing ends.

With the above, in the print preparation processing, the conveyance unit 40 conveys (rewinds) the ink ribbon 7 before the cleaning processing N is performed so that the thermal printer 100 performs the cleaning processing N using the used region Ru1.

In addition, the print preparation processing is performed when both or one of the paper mounting operation and the ink ribbon mounting operation is performed. That is, when both or one of the ink ribbon 7 and the recording paper 6 is mounted on the thermal printer 100, the thermal printer 100 performs the cleaning processing N and then performs the feed cutting processing (cutting processing).

As described above, according to the present embodiment, the thermal printer 100 uses the ink ribbon 7 having a function of cleaning the thermal head 5 by heating the ink ribbon 7. The thermal printer 100 performs cleaning processing for cleaning the thermal head 5 (cleaning processing N) using the used region Ru1. In the cleaning processing, the thermal head 5 applies to the used region Ru1 of the ink ribbon 7 the heat of the heat quantity which does not sublime the dye coated on the ink ribbon 7 and which is for performing the cleaning. Thus, the thermal head can be cleaned without using the cassette head cleaner.

In addition, the thermal printer 100 performs cleaning processing using the used region Ru1 of the ink ribbon 7 (cleaning processing N). Therefore, the cleaning processing can be performed without using (consuming) an unused region of the ink ribbon 7. Therefore, the cost related to the cleaning processing can be reduced.

In addition, in the present embodiment, when both or one of the paper mounting operation and the ink ribbon mounting operation is performed, the feed cutting processing (cutting processing) is performed after the cleaning processing N is performed. Therefore, when both or one of the paper mounting operation and the ink ribbon mounting operation is performed, dust attached to the thermal head 5 can be removed before the next printing processing P is started.

In addition, according to the present embodiment, the thermal head 5 is cleaned using the back surface of the ink ribbon 7. Therefore, the thermal head 5 can be cleaned without mounting the cassette head cleaner having the cleaning sheet on the thermal printer.

In addition, in the present embodiment, the cleaning processing N is performed immediately before the feed cutting processing (feed and cut) is performed. Therefore, the time required for the print preparation processing becomes longer. However, since the cleaning processing N is performed, for example, even if the above-described deposit exists on the thermal head 5, the deposit can be reliably removed.

In addition, in the present embodiment, the cleaning processing N is performed using the paper cleaning region included in the paper tip portion. It should be noted that the paper tip portion is separated from the recording paper 6, and the paper tip portion is ejected from the thermal printer 100. Therefore, even if the printing processing P is performed after the cleaning processing N is performed, the cleaning processing N does not affect the printing quality of the printed object obtained by the printing processing P. In addition, when the printing processing P is performed after the print preparation processing is performed, it is possible to obtain a high-quality printed object without scratches or the like caused by ink residue, dust, and the like.

It should be noted that when the thermal printer is installed in a dusty place, if the ink ribbon is removed from the thermal printer in order to clean the thermal head, dust may adhere to the ink ribbon. The dusty place is outdoors, for example. In this case, when the ink ribbon is used for the thermal printer after cleaning the thermal head, there is a problem that dust adheres to the thermal head again.

It should be noted that in the present embodiment, the print preparation processing described above is performed even when the paper mounting operation is performed with the ink ribbon 7 mounted on the thermal printer 100. In this case, the cleaning processing can be performed without removing the ink ribbon. Therefore, the above problem can be solved.

### Second Embodiment

Hereinafter, a region other than the transfer region Rt1 in the used region Ru1 of the ink ribbon 7 is also referred to as “used non-transfer region”. The used non-transfer region is included in the used region Ru1.

The configuration of the present embodiment is a configuration in which cleaning is performed using the used non-transfer region of the ink ribbon 7 (hereinafter, also referred to as “configuration CtA”). The thermal printer in the configuration CtA is the thermal printer 100.

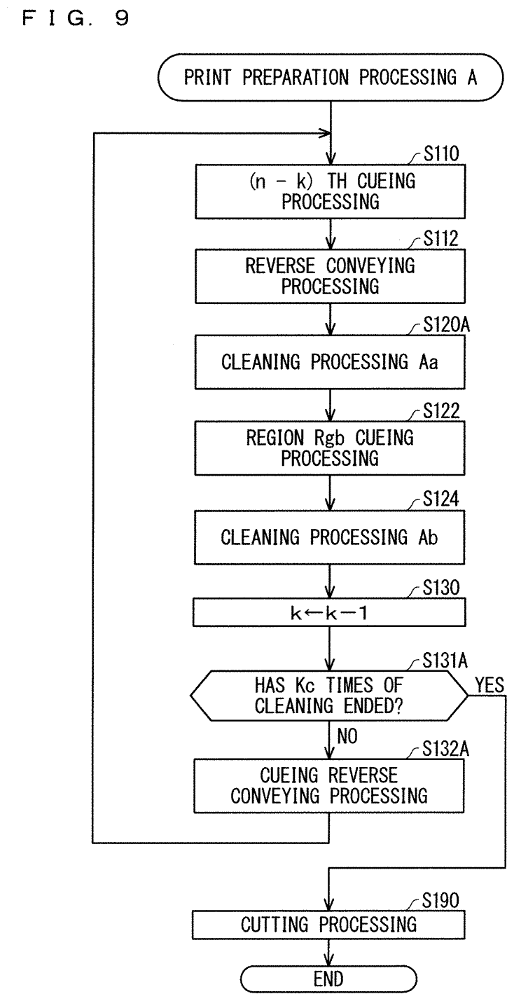

Next, processing performed by the thermal printer 100 to which the configuration CtA is applied (hereinafter, also referred to as “print preparation processing A”) will be described. FIG. 9 is a flowchart of the print preparation processing A according to the second embodiment. The print preparation processing A is performed when the user performs both or one of the paper mounting operation and the ink ribbon mounting operation.

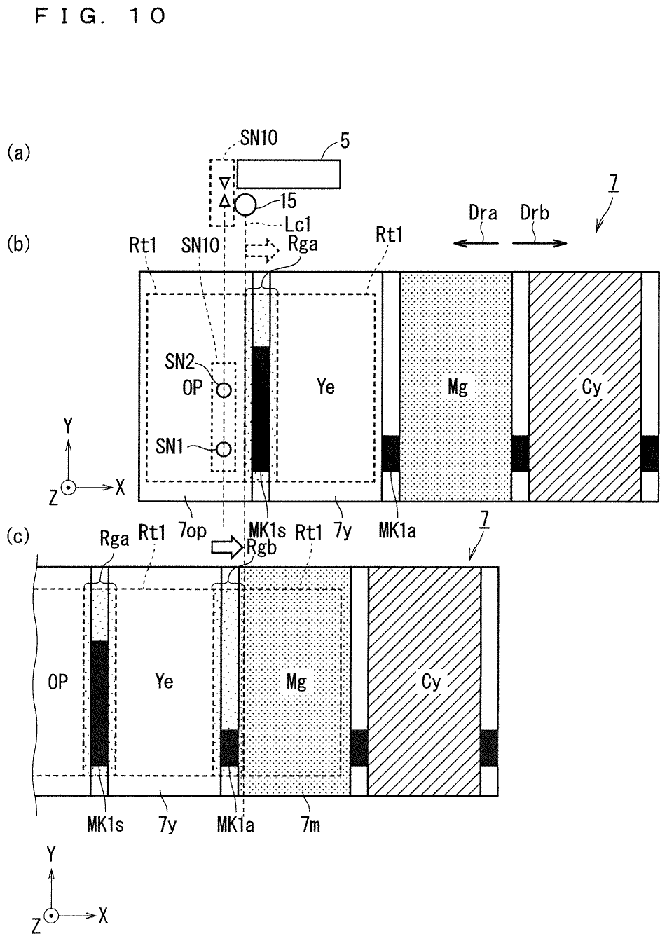

FIGS. 10A, 10B, and 10C are diagrams for illustrating a part of the print preparation processing A according to the second embodiment. FIG. 10A is a diagram mainly showing the thermal head 5 and the sensor SN10. FIGS. 10B and 10C are plan views for illustrating a part of the print preparation processing A.

Here, in order to describe an example of the print preparation processing A, the following premise Pm2 is considered. On the premise Pm2, the used transfer material exists, and the ink ribbon 7 has the used region Ru1. In addition, on the premise Pm2, the paper mounting operation and the ink ribbon mounting operation are performed. In addition, on the premise Pm2, all the transfer materials existing on the direction Dra side of the dye 7yn in FIG. 3 are used transfer materials.

In addition, on the premise Pm2, the ink ribbon mounting operation is performed by the user so that the heating position LC1 is a position within the transfer region Rt1 of the dye 7yn in FIG. 3. That is, on the premise Pm2, the reference transfer material (n-th transfer material) is the dye 7yn (dye 7y). In addition, on the premise Pm2, the value of the cleaning frequency Kc is 4. The initial value of k is Kc. Therefore, on the premise Pm2, the target transfer material being the (n−k)th transfer material is the dye 7y being the used transfer material. In addition, the target transfer material exists within the used region Ru1.

Hereinafter, the cleaning processing included in the print preparation processing A is also referred to as “cleaning processing Aa” or “cleaning processing Ab”. In addition, on the premise Pm2, performing the paper mounting operation and the ink ribbon mounting operation executes the print preparation processing A.

In the print preparation processing A, the processing of steps S110, S112, S120A, S122, S124, S130, and S131A is performed in the order of the steps S110, S112, S120A, S122, S124, S130, and S131A.

In step S110, the (n−k)th cueing processing is performed. In the first (n−k)th cueing processing on the premise Pm2, the target transfer material (dye 7y) being the (n−4)th transfer material is cued. Specifically, the conveyance unit 40 conveys (rewinds) the ink ribbon 7 in the direction Drb so that the position of the target transfer material is the printing start position. The conveyance of the ink ribbon 7 by the conveyance unit 40 is performed based on the detection state of the marks MK1s and MK1a by the sensor SN10 (sensors SN1 and SN2). Thus, the position of the tip (left end) of the transfer region Rt1 of the target transfer material (dye 7y) becomes the heating position LC1.

In addition, in the (n−k)th cueing processing, the cueing of the paper cleaning region at the paper tip portion is performed. Specifically, the conveyance roller pair 13 conveys the recording paper 6 so that the position of the paper cleaning region is the printing start position.

In the present embodiment, cleaning is performed using the regions Rga and Rgb. The region Rga is a region in the ink ribbon 7 between two transfer regions Rt1 included in two adjacent transfer materials. Each of the regions Rga and Rgb is a region not used for printing. It should be noted that on the premise Pm2, each of the regions Rga and Rgb is a used non-transfer region.

For example, the region Rga is a region between the transfer region Rt1 of the protective material lop and the transfer region Rt1 of the dye 7y in the ink ribbon 7, as shown in FIGS. 3 and 10B. The region Rga is a region adjacent to the transfer region Rt1 of the target transfer material in the direction Dra. It should be noted that the region Rga adjacent to the transfer region Rt1 of the dye 7y includes the mark MK1s. The region Rgb adjacent to the transfer region Rt1 of the dye 7y includes the mark MK1a.

The region Rgb is a region between the transfer region Rt1 of the dye 7y and the transfer region Rt1 of the dye 7m in the ink ribbon 7, as shown in FIG. 10C. The region Rgb is a region adjacent to the transfer region Rt1 of the target transfer material in the direction Drb. The size of the region Rga is the same as the size of the region Rgb. Hereinafter, the length of each of the region Rga and the region Rgb in the ribbon conveying direction (X-axis direction) is also referred to as “length Lsc”.

In step S112, reverse conveying processing is performed. The reverse conveying processing is processing of conveying the target transfer material in the direction Drb. That is, in the reverse conveying processing, the ink ribbon 7 is rewound. Specifically, in the reverse conveying processing, the conveyance unit 40 conveys the ink ribbon 7 in the direction Drb so that the tip (left end) of the region Rga adjacent to the transfer region Rt1 of the target transfer material is at the heating position LC1.

In step S120A, the cleaning processing Aa is performed. In the cleaning processing Aa, first, the state of the platen roller 15 is set to the above-described platen contact state. Then, with the region Rga adjacent to the transfer region Rt1 of the target transfer material as a target, the ribbon conveying processing Aa, the paper conveying processing Aa, and the transfer processing Aa are simultaneously performed.

In the ribbon conveying processing Aa, the conveyance unit 40 conveys the ink ribbon 7 in the direction Dra by the length Lsc with the ink ribbon 7 being in contact with the thermal head 5.

In the paper conveying processing Aa, the conveyance roller pair 13 conveys the recording paper 6 in the paper forward conveying direction (−X direction) by the length Lsc.

In the transfer processing Aa, during the period in which the ink ribbon 7 and the recording paper 6 are being conveyed, the thermal head 5 applies the heat of the above-described heat quantity Hq0 to the used region Ru1 of the ink ribbon 7 under the control of the print control unit 22. Specifically, in the transfer processing Aa, the thermal head 5 applies the heat of the heat quantity Hq0 to the entire region Rga being the used non-transfer region.

The ribbon conveying processing Aa, the paper conveying processing Aa, and the transfer processing Aa can clean the thermal head 5 using the region Rga of the ink ribbon 7.

In step S122, region Rgb cueing processing is performed. In the region Rgb cueing processing, the cueing of the region Rgb is performed. Specifically, the conveyance unit 40 conveys the ink ribbon 7 in the direction Dra so that the left end position of the region Rgb becomes the printing start position.

In step S124, the cleaning processing Ab is performed. In the cleaning processing Ab, with the region Rgb of the ink ribbon 7 as a target, the above-described ribbon conveying processing Aa, the above-described paper conveying processing Aa, and the transfer processing Ab are performed simultaneously.

In the transfer processing Ab, during the period in which the ink ribbon 7 and the recording paper 6 are being conveyed, the thermal head 5 applies the heat of the above-described heat quantity Hq0 to the used region Ru1 of the ink ribbon 7 under the control of the print control unit 22. Specifically, in the transfer processing Ab, the thermal head 5 applies the heat of the heat quantity Hq0 to the entire region Rgb being the used non-transfer region.

The ribbon conveying processing Aa, the paper conveying processing Aa, and the transfer processing Ab can clean the thermal head 5 using the region Rgb of the ink ribbon 7.

In step S130, the control unit 20 decrements the value of k by 1.

In step S131A, it is determined whether Kc times of cleaning processing has ended. Specifically, the control unit 20 determines whether the cleaning processing Aa and Ab has been performed Kc times. If the value of k is 0, the control unit 20 determines that the cleaning processing Aa and Ab has been performed Kc times. On the other hand, if the value of k is 1 or more, the control unit 20 determines that the cleaning processing Aa and Ab has not been performed Kc times.

If YES in step S131A, the processing proceeds to step S190. On the other hand, if NO in step S131A, the processing proceeds to step S132A.

On the premise Pm2, Kc is 4, and the k at the time when the processing in step S131A is performed for the first time is 3, so that NO is determined in step S131A and the processing proceeds to step S132A.

It should be noted that on the premise Pm2, when the first step S124 ends, the sensor SN10 exists at a position where the mark MK1a corresponding to the dye 7m cannot be normally detected in a plan view (XY plane). Therefore, the processing in step S132A is performed.

In step S132A, cueing reverse conveying processing is performed. In the cueing reverse conveying processing, the ink ribbon 7 is rewound so that the next transfer material after the target transfer material can be cued. Specifically, in the cueing reverse conveying processing, first, the state of the platen roller 15 is set to the above-described platen non-contact state.

Next, in a plan view (XY plane), the conveyance unit 40 conveys the ink ribbon 7 in the direction Drb so that the position of the sensor SN10 is the position on the direction Dra side of the mark MK1a corresponding to the next transfer material (for example, dye 7m). Then, the processing in step S110 is performed again.

It should be noted that in the second (n−k)th cueing processing on the premise Pm2, the processing for cueing the (n−3)th transfer material (dye 7m) is performed in the same manner as described above. In addition, in the second (n−k)th cueing processing, the cueing of the paper cleaning region at the paper tip portion is performed as described above.

In the print preparation processing A, the processing in steps S110 to S132A are repeated until YES is determined in step S131. On the premise Pm2, the cleaning processing Aa and Ab is performed Kc times. If YES is determined in step S131, the processing proceeds to step S190.

In step S190, the cutting processing (feed cutting processing) is performed as in the first embodiment. Thus, the paper tip portion including the paper cleaning region is ejected from the thermal printer 100. With the above, the print preparation processing A ends.

With the above, in the print preparation processing A, the conveyance unit 40 conveys (rewinds) the ink ribbon 7 before the cleaning processing is performed so that the thermal printer 100 performs the cleaning processing using the used region Ru1.

In addition, in the print preparation processing A, the thermal printer 100 performs the cleaning processing Aa using the region Rga (used non-transfer region). In addition, the thermal printer 100 performs cleaning processing Ab using the region Rgb (used non-transfer region).

In addition, the print preparation processing A is performed when both or one of the paper mounting operation and the ink ribbon mounting operation is performed. That is, when both or one of the ink ribbon 7 and the recording paper 6 is mounted on the thermal printer 100, the thermal printer 100 performs the cleaning processing Aa and Ab and then the feed cutting processing (cutting processing).

As described above, according to the present embodiment, the cleaning processing is performed using the used non-transfer regions (regions Rga and Rgb) included in the used region Ru of the ink ribbon 7. It should be noted that the used non-transfer region is a region not used for printing. Therefore, also in the present embodiment, the same effect as in the first embodiment can be obtained. For example, even when ink residue is attached to the thermal head 5 when the ink ribbon mounting operation is performed, the ink residue can be reliably removed.

In addition, since the cleaning processing is performed using the used non-transfer regions (regions Rga and Rgb), the effect can be also obtained that the breakage of the ink ribbon 7 can be made less likely to occur than in the above-described configuration in which the cleaning processing is performed using the transfer region Rt1 included in the used region Ru.

It should be noted that in the present embodiment, in the cleaning processing Aa and Ab, the entire regions Rga and Rgb including any one of the mark MK1s and the mark MK1a are used, but the present invention is not limited to this. If the width of each of the regions Rga and Rgb is made sufficiently long, the rewinding processing of the ink ribbon to be performed before the transfer processing of each transfer material is unnecessary.

In addition, in the cleaning processing of the present embodiment, both the regions Rga and Rgb corresponding to each transfer material are used, but the present invention is not limited to this. In the cleaning processing, only one of the regions Rga and Rgb corresponding to each transfer material may be used.

(Functional Block Diagram)

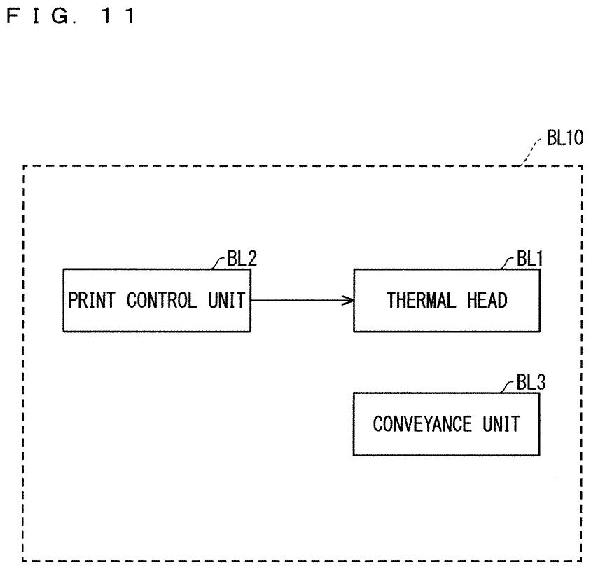

FIG. 11 is a block diagram illustrating a characteristic functional configuration of a thermal printer BL10. The thermal printer BL10 corresponds to the thermal printer 100. In other words, FIG. 11 is a block diagram illustrating main functions related to the present invention, among the functions of the thermal printer BL10.

The thermal printer BL10 performs printing processing for forming an image on the recording paper using the ink ribbon having a function of cleaning the thermal head by heating the ink ribbon.

The thermal printer BL10 functionally includes a thermal head BL1, a print control unit BL2, and a conveyance unit BL3.

The thermal head BL1 has a function of emitting heat. The thermal head BL1 corresponds to the thermal head 5. The print control unit BL2 controls the thermal head BL1. The print control unit BL2 corresponds to the print control unit 22.

The conveyance unit BL3 has a function of conveying an ink ribbon. The conveyance unit BL3 corresponds to the conveyance unit 40.

The ink ribbon has a used region. The used region is a region used in the printing processing in the ink ribbon.

The conveyance unit BL3 conveys the ink ribbon before the cleaning processing is performed so that the thermal printer BL10 performs the cleaning processing using the used region. The thermal printer BL10 performs cleaning processing for cleaning the thermal head BL1 using the used region.

In the cleaning processing, under the control of the print control unit BL2, the thermal head BL1 applies to the used region of the ink ribbon the heat of the heat quantity which does not sublime the dye coated on the ink ribbon and which is for performing the cleaning.

(Other Modifications)

As described above, the thermal printer according to the present invention has been described based on each embodiment, but the present invention is not limited to each embodiment. Without departing from the gist of the present invention, those obtained by performing modifications conceived by those skilled in the art on each embodiment are also included in the present invention. That is, in the present invention, each embodiment can be freely combined, and each embodiment can be appropriately modified, or omitted within the scope of the present invention.

The thermal printer 100 does not need to include all the components shown in the drawings. That is, the thermal printer 100 has to include only the minimum components that can achieve the effects of the present invention.

In addition, the function of the print control unit 22 included in the thermal printer 100 may be achieved by a processing circuit.

The processing circuit is a circuit for controlling the thermal head.

It should be noted that the conveyance unit conveys the ink ribbon before the cleaning processing is performed so that the thermal printer performs the cleaning processing using the used region. The used region is a region in the ink ribbon used in the printing processing.

In the cleaning processing, under the control of the processing circuit, the thermal head applies to the used region of the ink ribbon the heat of the heat quantity which does not sublime the dye applied to the ink ribbon and which is for performing the cleaning.

The processing circuit may be dedicated hardware. In addition, the processing circuit may be a processor that executes a program stored in a memory. The processor is, for example, a central processing unit (CPU), a central processing apparatus, an arithmetic apparatus, a microprocessor, a microcomputer, a digital signal processor (DSP), or the like.

Hereinafter, a configuration in which the processing circuit is dedicated hardware is also referred to as “configuration Cs1”. In addition, hereinafter, a configuration in which the processing circuit is a processor is also referred to as “configuration Cs2”.

In the configuration Cs1, a single circuit, a composite circuit, a programmed processor, a parallel programmed processor, an application specific integrated circuit (ASIC), a field programmable gate array (FPGA), or a combination thereof corresponds to the processing circuit, for example. The function of the print control unit 22 may be achieved by one processing circuit.

It should be noted that a configuration in which all or a part of each component included in the thermal printer 100 is represented by hardware is as follows, for example. Hereinafter, a thermal printer in which all or a part of each component included in the thermal printer 100 is represented by hardware is also referred to as “thermal printer hd10”.

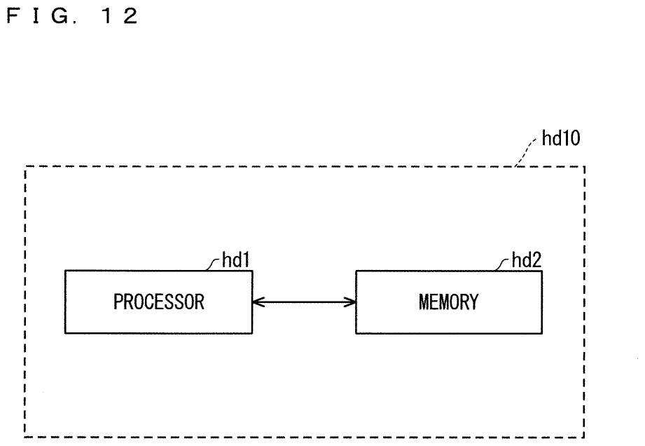

FIG. 12 is a hardware configuration diagram of the thermal printer hd10. With reference to FIG. 12, the thermal printer hd10 includes a processor hd1 and a memory hd2. The memory hd2 is a nonvolatile or volatile semiconductor memory such as a random access memory (RAM), a read only memory (ROM), a flash memory, an EPROM, and an EEPROM. In addition, the memory hd2 may be, for example, a magnetic disk, a flexible disk, an optical disc, a compact disc, a mini disc, a DVD, or the like. In addition, the memory hd2 may be any storage medium to be used in the future.

In the configuration Cs2, the processing circuit is the processor hd1. In the configuration Cs2, the function of the print control unit 22 is achieved by software, firmware, or a combination of software and firmware. The software or firmware is described as a program and stored in the memory hd2.

In addition, in the configuration Cs2, the processing circuit (processor hd1) reads the program stored in the memory hd2 and executes the program, whereby the function of the print control unit 22 is achieved. That is, the memory hd2 stores the following program.

The program is a program for causing the processing circuit (processor hd1) to execute the step of controlling the thermal head.

It should be noted that the conveyance unit conveys the ink ribbon before the cleaning processing is performed so that the thermal printer performs the cleaning processing using the used region. The used region is a region in the ink ribbon used in the printing processing.

In the cleaning processing, under the control of the processing circuit, the thermal head applies to the used region of the ink ribbon the heat of the heat quantity which does not sublime the dye applied to the ink ribbon and which is for performing the cleaning.

In addition, the program also causes a computer to execute a procedure of processing performed by the print control unit 22, a method of performing the processing, and the like.

As in the above configuration Cs1 and configuration Cs2, the processing circuit can achieve each function described above by hardware, software, firmware, or a combination thereof.

In addition, the present invention may be achieved as a cleaning method in which the operations of characteristic components included in the thermal printer 100 are performed as steps.

In addition, the present invention may be achieved as a program that causes a computer to execute each step included in the cleaning method. In addition, the present invention may be achieved as a computer-readable recording medium that stores the program. In addition, the program may be delivered via a transmission medium such as the Internet.

All the numerical values used in each above embodiment are exemplary numerical values for specifically describing the present invention. That is, the present invention is not limited to each of the numerical values used in each above embodiment.

It should be noted that in the present invention, each embodiment can be freely combined, and each embodiment can be appropriately modified, or omitted within the scope of the present invention.

For example, in each above embodiment, the ink ribbon provided with the protective material 7op is used, but the present invention is not limited to this. In each above embodiment, an ink ribbon provided with no protective material 7op may be used.

Although the present invention is described in detail, the above description is in all aspects illustrative, and the present invention is not limited to the above description. It is understood that innumerable modifications not illustrated can be envisaged without departing from the scope of the present invention.

### EXPLANATION OF REFERENCE SIGNS

5, BL1: thermal head

6: recording paper

7: ink ribbon

22, BL2: print control unit

23: machine control unit

40, BL3: conveyance unit

100, BL10, hd10: thermal printer

1. A thermal printer configured to perform printing processing for forming an image on a recording paper using an ink ribbon having a function of cleaning a thermal head by heating the ink ribbon, the thermal printer comprising:
the thermal head having a function of emitting heat;
a print control unit configured to control the thermal head; and
a conveyance unit having a function of conveying the ink ribbon,
wherein the ink ribbon has a used region,
wherein the used region is a region used in the printing processing in the ink ribbon
wherein the conveyance unit conveys the ink ribbon before the cleaning processing is performed so that the thermal printer performs cleaning processing using the used region,
wherein the thermal printer performs the cleaning processing for performing the cleaning on the thermal head using the used region, and
wherein in the cleaning processing, under control of the print control unit, the thermal head applies to the used region of the ink ribbon heat of heat quantity which does not sublime dye coated on the ink ribbon and which is for performing the cleaning.

2. The thermal printer according to claim 1,
wherein the thermal printer has a function of performing feed cutting processing,
wherein the feed cutting processing is processing of cutting the recording paper so that a tip portion of the recording paper is separated from the recording paper, and
wherein when both or one of the ink ribbon and the recording paper is mounted on the thermal printer, the thermal printer performs the cleaning processing and then performs the feed cutting processing.

3. The thermal printer according to claim 1,
wherein in the ink ribbon, a transfer region coated with the dye used for forming the image exists, and
wherein the thermal printer performs the cleaning processing using the entire transfer region included in the used region of the ink ribbon.

4. The thermal printer according to claim 1,
wherein in the ink ribbon, a transfer region coated with the dye used for forming the image exists, and
wherein the thermal printer performs the cleaning processing using a region other than the transfer region in the used region of the ink ribbon.
